(19) United States
(12) Patent Application Publication
(10) Pub. No.: US 2017/0169450 A1
(43) Pub. Date: Jun. 15, 2017

(54) VIRTUAL PANEL CREATION METHOD AND APPARATUS

(71) Applicant: MASTERCARD INTERNATIONAL INCORPORATED, Purchase, NY (US)

(72) Inventors: Ashutosh GUPTA, Gurgaon (IN); Anshul PANDEY, Gurgaon (IN); Henry WEINBERGER, New York, NY (US)

(21) Appl. No.: 14/966,986

(22) Filed: Dec. 11, 2015

(51) Int. Cl. G06Q 30/02; G06Q 40/00; G06Q 10/06; G06F 17/30

(52) U.S. Cl. CPC G06Q 30/0204; G06F 17/3053; G06F 17/30598; G06Q 40/12; G06Q 10/067

(57) ABSTRACT

A system, method, and computer readable storage medium configured to process, analyze, and model of large amounts of data from a sample of accountholders that is representative of the overall consumer population across key geographic, demographic, and behavior dimensions in an in-memory modeling environment.

### BACKGROUND

Field of the Disclosure

Aspects of the disclosure relate in general to computer science. Aspects include an apparatus, system, method and computer readable storage medium to process, analyze, and model large amounts of data.

Description of the Related Art

In the technical fields of computer analytics and operations research, pattern detection includes a number of methods for extracting meaning from large and complex data sets through a combination of operations research methods, graph theory, data analysis, clustering, and advanced mathematics.

Unlike machine learning, deep learning, or data mining, pattern detection is data agnostic, requiring only an ingestible data format to compute correlations in data.

Graph algorithms detect patterns of co-occurrence to create a holistic representation of connections a given set of data. Analysis has been applied to industries including transportation, manufacturing, and other fields, such as computer science.

Another different area of technology is computer modeling or computer simulation.

A computer simulation is a simulation, run on a single computer, or a network of computers, to reproduce behavior of a system. The simulation uses an abstract model (a computer model, or a computational model) to simulate the system. Computer simulations have become a useful part of mathematical modeling of many natural systems in physics (computational physics), astrophysics, climatology, chemistry and biology, human systems in economics, psychology, social science, and engineering. Simulation of a system is represented as the running of the system's model. It can be used to explore and gain new insights into new technology and to estimate the performance of systems too complex for analytical solutions.

Computer simulations vary from computer programs that run a few minutes to network-based groups of computers running for hours to ongoing simulations that run for days. The scale of events being simulated by computer simulations has far exceeded anything possible (or perhaps even imaginable) using traditional paper-and-pencil mathematical modeling. Over 10 years ago, a desert-battle simulation of one force invading another involved the modeling of 66,239 tanks, trucks and other vehicles on simulated terrain around Kuwait, using multiple supercomputers in the Department of Defense High Performance Computer Modernization Program. Other computer modeling examples include: a billion-atom model of material deformation, a 2.64-million-atom model of the complex maker of protein in all organisms called a “ribosome,” a complete simulation of the life cycle of mycoplasma genitalium, and the “Blue Brain” project at the École Polytechnique Fédérale de Lausanne (EPFL) in Switzerland to create the first computer simulation of the entire human brain, right down to the molecular level.

### SUMMARY

Embodiments include a system, device, method and computer readable medium configured to model a virtual panel.

A system embodiment includes a network interface, a processor, and a non-transitory computer-readable storage medium. The network interface retrieves account records. Each of the account records contains a plurality of transaction records. The transaction records include: an account identification code, a date of the transaction, an amount of a transaction, and a merchant identifier. The processor filters the account records within a set time period based on the date of the transaction, a minimum number of transactions per account record and a maximum number of transactions per account record, resulting in filtered account records. The processor groups similar behaving industries on the basis of periodic spend at least in part on the amount of the transaction, resulting in industry clusters. The processor creates segments based on the industry clusters. For each of the created segments, the processor: tags the filtered account records with transactions in the created segment based on the merchant identifier, creates a derived industry spend distribution based on the tagged filtered account records, and computes a statistical difference based on the derived industry spend distribution with an actual census spend distribution. The processor optimizes the created segments by ranking each of the created segments based on the statistical differences, and maps the created segments into a geographic distribution, resulting in a virtual panel. The virtual panel is saved to a non-transitory computer-readable storage medium.

### BRIEF DESCRIPTION OF THE DRAWINGS

FIG. 1 depicts a block diagram of a modeling device configured to model a virtual panel.

FIGS. 2A-2B flowchart a method embodiment to model a virtual panel.

### DETAILED DESCRIPTION

A panel is a data collection mechanism used to collect quantitative or qualitative information about the participants' personal and economic habits set against their particular demographic. Typically, incentivized (“paid”) surveys are considered to be more likely to catch a wider and more representative range of respondents compared to unpaid surveys. The incentive is used to ensure that samples are as representative as possible, and that responses are not tilted towards those passionately interested in the subject of the particular survey.

To construct a panel, market research companies recruit participants and gather information. Typically, thousands of respondents are contacted over weeks and months to conduct interviews through telephone, mail or the Internet.

Large corporations from around the world pay millions of dollars to research companies to collect data on public opinions, product reviews and consumer behavior by using these surveys. The completed surveys directly influence the development of products and services from these companies.

When a research company needs respondents from a demographic they cannot reach, they can reach out to a nationwide or specialty panel. By offering a cash incentive to respondents in return for feedback these companies are able to fill quotas and collect information that reflects the attitudes or behavior in the overall universe of consumers being sought by the client.

As panels result from surveys of people, the honesty and correctness of survey responses directly affect the accuracy of a panel. It is also very important that the overall composition of the panel reflects the demographic and geographic characteristics of the broader consumer population in order for the data collected from the panel to reflect the overall marketplace.

Aspects of the disclosure include using a selected set of transactions to create a virtual panel model, which models behavior from a sample of consumers that is representative of the overall consumer population across key geographic, demographic, and behavior dimensions in an in-memory modeling environment.

One aspect of the disclosure includes the realization that a virtual panel of consumer behavior may be constructed from the billions of financial transactions that occur in a payment network. An example payment network includes MasterCard International Incorporated of Purchase, N.Y. Financial transactions may include credit, debit, charge, prepaid payment card, checking, savings, balance-transfer transactions, and the like.

Another realization is that virtual panels may be used to create stable merchant benchmarking products.

Another aspect of the disclosure includes the understanding that not all payment network financial transactions are applicable for use in a virtual panel. First, not all financial accounts are equally representative of overall consumer behavior. Second, transaction data for a virtual panel is drawn from a stratified, quota-driven sample of financial accounts that would match the applicable population across a number of possible key geographic, demographic and behavioral dimensions. In one embodiment, such a panel is more representative of the United States consumer population than the raw sample of payment card account holders, and would continue to be representative in the face of market, consumer preference and payment network share changes.

In yet another aspect, the virtual panel creation and maintenance of customer inflow/outflow would be much more efficient than conventional panels, since panel members would not need to be recruited, but would become eligible simply by their characteristics from the payment network's transaction database. As a consequence, there could be hundreds of thousands—if not millions of panel members. Additionally, such a virtual panel has the added benefit of measuring panel members' actual purchase behavior, not just what the panel members report.

In another aspect, as panel members are not recruited, no payments to panelists are involved.

Embodiments of the present disclosure include a system, method, and computer readable storage medium configured to model a virtual panel in an in-memory modeling environment.

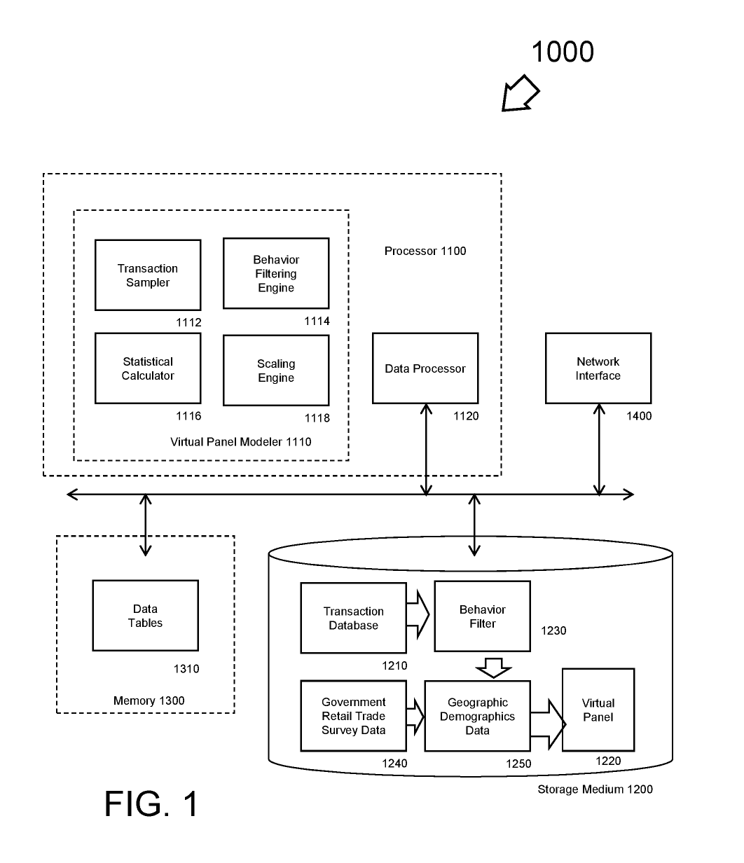

FIG. 1 illustrates an embodiment of a modeling device 1000 configured to model a virtual panel in an in-memory modeling environment, constructed and operative in accordance with an embodiment of the present disclosure.

Modeling device 1000 may run a multi-tasking operating system (OS) and include at least one processor or central processing unit (CPU) 1100, a non-transitory computer readable storage medium 1200, and computer memory 1300. An example operating system may include Advanced Interactive Executive (AIX™) operating system, UNIX operating system, or LINUX operating system, and the like.

Processor 1100 may be any central processing unit, microprocessor, micro-controller, computational device or circuit known in the art. It is understood that processor may store data temporarily in a Random Access Memory (RAM), not shown.

As shown in FIG. 1, processor 1100 is functionally comprised of a virtual panel modeler 1110 and a data processor 1120.

Virtual panel modeler 1110 is a modeling environment configured to execute a virtual model. In this embodiment, the virtual model is a virtual panel. Furthermore, virtual panel modeler 1110 may comprise: transaction sampler 1112, behavior filtering engine 1114, statistical calculator 1116, and scaling engine 1118.

Transaction sampler 1112 is the element of processor 1100 to sample, slice, variable screen, and otherwise process a dataset of transaction data into manageable size.

Behavior filtering engine 1114 enables processor 1100 to construct and execute filters for transaction data.

Statistical calculator 1116 is the portion of the processor 1100 that performs statistical analysis. For example, statistical calculator 1116 may be able to determine the total variation distance between two probability measures. In some embodiments, statistical calculator is configured to perform a Kolmogorov-Smirnov test (K-S test), Shapiro-Wilk test, Anderson-Darling test, or the like.

Scaling engine 1118 is the portion of processor 1100 to scale modeling information into a virtual panel.

Data processor 1120 enables processor 1100 to interface with memory 1300, storage medium 1200, network interface 1400 or any other component not on the processor 1100. The data processor 1120 enables processor 1100 to locate data on, read data from, and write data to these components.

These structures may be implemented as hardware, firmware, or software encoded on a computer readable medium, such as storage medium 1200. Further details of these components are described with their relation to method embodiments below.

Memory 1300 may be any computer memory known in the art for volatile or non-volatile storage of data or program instructions. An example memory 1300 may be Random Access Memory (RAM). As shown, memory 1300 may store data tables 1310, for instance.

Computer readable storage medium 1200 may be a conventional read/write memory such as a magnetic disk drive, floppy disk drive, optical drive, compact-disk read-only-memory (CD-ROM) drive, digital versatile disk (DVD) drive, high definition digital versatile disk (HD-DVD) drive, Blu-ray disc drive, magneto-optical drive, optical drive, flash memory, memory stick, transistor-based memory, magnetic tape or other computer readable memory device as is known in the art for storing and retrieving data. Significantly, computer readable storage medium 1200 may be remotely located from processor 1100, and be connected to processor 1100 via a network such as a local area network (LAN), a wide area network (WAN), or the Internet.

In addition, as shown in FIG. 1, storage medium 1200 may also contain a transaction database 1210, behavior filter 1230, government retail survey data 1240, geographic demographics data 1240, and a virtual panel 1220. Transaction database 1210 is a database of payment card transactions at a payment network; the transaction database 1210 may contain all payment cardholder accounts that have financial transactions within a determined time period. Virtual panel 1220 is configured to store the model or result of the virtual panel modeler 1110. Behavior filter 1230 is a financial transaction filter generated and executed by behavior filtering engine 1114. Government retail survey data 1240 is data provided by a government or commercial entity, used to measure the overall size of and trends within the consumer spending universe, in total and by various types of goods or services. Using Merchant Category Codes with card transactions, the virtual panel modeler 1110 can determine the type of industry a financial transaction is taking place at. Geographic demographics data 1250 is private entity or census distribution information on the overall consumer universe. Geographic demographics data 1250 enables virtual panel modeler 1110 to more accurately represent a specific geographical area. For example, if 1% of U.S. consumers live in Cook County, Illinois, then 1% of a nationwide virtual panel 1220 is derived from Cook County.

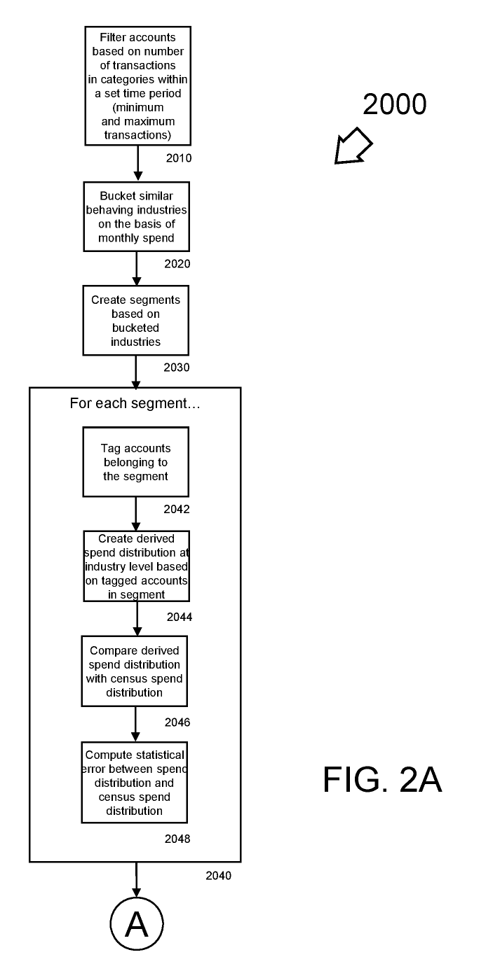

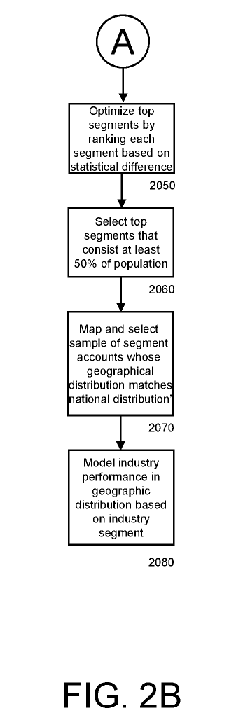

It is understood by those familiar with the art that one or more of these databases 1210-1250 may be combined in a myriad of combinations. These structures 1210-1250 may be any relational database known in the art, such as SQL, SQLite, MySQL, PosgreSQL, or the like. The function of these structures may best be understood with respect to the flowcharts of FIG. 2, as described below.

Network interface 1400 may be any data port as is known in the art for interfacing, communicating or transferring data across a computer network, examples of such networks include Transmission Control Protocol/Internet Protocol (TCP/IP), Ethernet, Fiber Distributed Data Interface (FDDI), token bus, or token ring networks. Network interface 1400 allows modeling device 1000 to communicate with acquirers, issuers and user computer systems.

We now turn our attention to method or process embodiments of the present disclosure depicted in FIGS. 2A-2B. It is understood by those known in the art that instructions for such method embodiments may be stored on their respective computer readable memory and executed by their respective processors.

FIGS. 2A-2B flowchart a modeling method 2000 embodiment to model for a virtual panel 1220 in an in-memory modeling environment, constructed and operative in accordance with an embodiment of the present disclosure. In this embodiment, the behavior filters 1230 are designed to identify a set of financial accounts whose transactional patterns are most reflective of the time series spend patterns seen in government retail survey data 1240. This process accounts for the fact that not all accountholder transactions received by a payment network are reflective of overall consumer behavior; this is due to the fact that a payment network's accountholders have significant geographic and demographic biases. Additionally, these biases change over time, making it difficult to adjust the raw transaction data in order to make it accurately reflect broader measures of consumer behavior.

In order to produce a virtual panel 1220 that more accurately reflects overall consumer behavior, the virtual panel 1220 is built from a subset of active payment network accounts. That subset may be selected using a set of quotas for various geo-demographic and/or behavioral cells such that the sample of accounts used for the reports would be more representative of the consumer population in their spend activity.

Accounts may be classified in their activity based on Merchant Category Codes (MCC), which is used to classify a business by the type of goods or services it provides. Typically, a MCC is a four-digit number assigned to the merchant.

Each account record includes purchase transactions made with the account number. It is understood that an account may have multiple purchase transaction records. The purchase transaction records include an account identification code (usually the account number), a date and time of the transaction, an amount of a transaction, and a merchant identifier. The merchant identifier indicates the merchant at which the transaction took place. From the merchant identified by the merchant identifier, a merchant category code can be determined.

At block 2010, the behavior filtering engine 1114 filters accounts, retrieved from transaction database 1210 by transaction sampler 1112, based on the number of transactions in merchant categories within a set time period, with both a minimum and maximum number of transactions. The set time period may be a month, a quarter, a year, or other predefined time period. In some embodiments, the behavior filtering engine 1114 uses a set time period provided by a user via the network interface. In essence, accounts must meet a minimum level of activity, and maximum level of activity during the set time period. An example behavior filter 1230 could filter in accounts transacting in at least one merchant category in the current and previous month, defining a minimum level of activity. Another behavior filter 1230 used could filter out accounts transacting in more than twenty merchant categories in the current and previous month, defining a maximum level of activity.

Similarly behaving industries are bucketed or clustered (grouped together) on the basis of monthly expenditure, block 2020 by virtual panel modeler 1110. It is understood that other periodic expenditure buckets may be created by other embodiments. It is known that certain industries contribute more to the economy than others. Transactions in these industries, as defined by their merchant category codes, logically weigh more heavily than less important industries. Suppose the top 25 industries contribute 80% of economic spending. Statistical calculator 1116 uses clustering techniques, such as k means, to these 25 available industries into 8-10 industry groups.

The statistical calculator 1116 creates segments based on industry combinations of the major 8-10 industry groups, block 2030. Typically, three industry groups are used to create each combination.

At block 2040, for each segment, blocks 2042-2048 are applied.

First, the filtered payment accounts are tagged belonging to the segment, block 2042.

A derived spend distribution is created at an industry level based on the tagged payment accounts in the segment, block 4044. The spend distribution is compared with census spend distributions from the government retail trade survey data 1240, block 2046. An example distribution comparison is shown at Table 1.

TABLE 1
example spend distribution comparison

| Segment 1 | INDUSTRY 1 | INDUSTRY 2 | INDUSTRY N |
|---|---|---|---|
| Spend share - Census | P % | Q % | R % |
| Spend share - MC | L % | M % | N % |

Using the comparison, at block 2048, statistical calculator 1116 can compute the statistical distance error term using the Euclidean distance formula for the three industry segments,

Error=[(P%−L%)²+(Q%−M%)²+(R%−N%))²]^{1/2}

At block 2050, statistical calculator 1116 optimizes the top segments by ranking each segment based on statistical difference. For example, suppose that there are six industries, lettered A-F. An example segment ranking may be:

TABLE 2
example statistical ranking of segments

| | Statistical | Rank based on min |
|---|---|---|
| Segment # | distance | statistical dist |
| A-B-C | 0.004 | 5 |
| A-B-D | 0.001 | 2 |
| A-B-E | 0.002 | 3 |
| A-C-D | 0.005 | 6 |
| A-C-E | 0.0005 | 1 |
| A-C-F | 0.003 | 4 |

As shown in the example in Table 2, segment with industry groups A-C-E have a lower statistical distance (error) than other segments, and would therefore be ranked as “1.” Similarly, the segment with industry groups A-B-D have the next lowest statistical difference, and so on.

Scaling engine 1118 selects the top segments that consist of at least 50% of the population, block 2060.

Scaling engine 1118 maps and selects a sample of segment accounts whose geographical distribution matches national distribution, as provided by geographic demographics data 1250, block 2070. For example, suppose the scaling engine 1118 uses 15 million accounts as representative number of accounts of the national population. Using geographic demographics data 1250, the scaling engine 1118 knows the number of accounts that should be from each of the geographic regions in the country. The scaling engine 1118 randomly selects payment accounts from the segment mapped geographic region. If the number of payment accounts is less than the representative number of accounts for the region, random accounts from the region are used to supplement the virtual panel 1220.

The resulting virtual panel 1220 models the industry performance in the geographic distribution based on the industry segment, block 2080. The virtual panel 1220 may then be stored on a non-transitory computer-readable storage medium. The resulting virtual panel 1220 may be the underlying driver to produce accurate analytics within a myriad of informational products. For example, the resulting virtual panel 1220 is able to monitor industry, merchant, and payment account issuer performance. Merchant performance may be modeled by scaling engine 1118.

The previous description of the embodiments is provided to enable any person skilled in the art to practice the disclosure. The various modifications to these embodiments will be readily apparent to those skilled in the art, and the generic principles defined herein may be applied to other embodiments without the use of inventive faculty. Thus, the present disclosure is not intended to be limited to the embodiments shown herein, but is to be accorded the widest scope consistent with the principles and novel features disclosed herein.

What is claimed is:

1. A virtual panel modeling method comprising:
retrieving account records, with a network interface, each of the account records containing a plurality of transaction records, the transaction records including: an account identification code, a date of the transaction, an amount of a transaction, and a merchant identifier;
filtering the account records with a processor within a set time period based on the date of the transaction, a minimum number of transactions per account record and a maximum number of transactions per account record, resulting in filtered account records;
grouping similar behaving industries on the basis of periodic spend at least in part on the amount of the transaction, resulting in industry clusters, with the processor;
creating segments based on the industry clusters, with the processor;
for each of the created segments, with the processor:
tagging the filtered account records with transactions in the created segment based on the merchant identifier;
creating a derived industry spend distribution based on the tagged filtered account records;
computing a statistical difference based on the derived industry spend distribution with an actual census spend distribution;
optimizing the created segments by ranking each of the created segments based on the statistical differences;
mapping the created segments into a geographic distribution, resulting in a virtual panel;
saving the virtual panel to a non-transitory computer-readable storage medium.

2. The virtual panel modeling method of claim 1, wherein the minimum number of transactions per account record is at least one merchant category in the current and previous month.

3. The virtual panel modeling method of claim 2, wherein the maximum number of transactions per account record is twenty merchant categories in the current and previous month.

4. The virtual panel modeling method of claim 3, wherein the computing the statistical difference based on the derived industry spend distribution with the actual census spend distribution is derived using the Euclidean distance formula.

5. The virtual panel modeling method of claim 4, wherein geographic demographics data is provided by census data.

6. The virtual panel modeling method of claim 4, wherein the set time period is defined by a user computer system.

7. The virtual panel modeling method of claim 4, wherein the set time period is a predefined time period.

8. A virtual panel modeling apparatus comprising:
a network interface configured to retrieve account records, each of the account records containing a plurality of transaction records, the transaction records including: an account identification code, a date of the transaction, an amount of a transaction, and a merchant identifier;
a processor configured to filter the account records within a set time period based on the date of the transaction, a minimum number of transactions per account record and a maximum number of transactions per account record, resulting in filtered account records, to group similar behaving industries on the basis of periodic spend at least in part on the amount of the transaction, resulting in industry clusters, to create segments based on the industry clusters;
the processor being configured to, for each of the created segments:
tag the filtered account records with transactions in the created segment based on the merchant identifier;
create a derived industry spend distribution based on the tagged filtered account records;
compute a statistical difference based on the derived industry spend distribution with an actual census spend distribution;
the processor being further configured to optimize the created segments by ranking each of the created segments based on the statistical differences, and to map the created segments into a geographic distribution, resulting in a virtual panel; and
a non-transitory computer-readable storage medium which is configured to save the virtual panel.

9. The virtual panel modeling apparatus of claim 8, wherein the minimum number of transactions per account record is at least one merchant category in the current and previous month.

10. The virtual panel modeling apparatus of claim 9, wherein the maximum number of transactions per account record is twenty merchant categories in the current and previous month.

11. The virtual panel modeling apparatus of claim 10, wherein the computing the statistical difference based on the derived industry spend distribution with the actual census spend distribution is derived using the Euclidean distance formula.

12. The virtual panel modeling apparatus of claim 11, wherein geographic demographics data is provided by census data.

13. The virtual panel modeling apparatus of claim 11, wherein the set time period is defined by a user computer system.

14. The virtual panel modeling apparatus of claim 11, wherein the set time period is a predefined time period.

15. A virtual panel modeling apparatus comprising:
means for retrieving account records, each of the account records containing a plurality of transaction records, the transaction records including: an account identification code, a date of the transaction, an amount of a transaction, and a merchant identifier;
means for filtering the account records within a set time period based on the date of the transaction, a minimum number of transactions per account record and a maximum number of transactions per account record, resulting in filtered account records;
means for grouping similar behaving industries on the basis of periodic spend at least in part on the amount of the transaction, resulting in industry clusters, with the processor;
means for creating segments based on the industry clusters;
for each of the created segments:
means for tagging the filtered account records with transactions in the created segment based on the merchant identifier;
means for creating a derived industry spend distribution based on the tagged filtered account records;
means for computing a statistical difference based on the derived industry spend distribution with an actual census spend distribution;
means for optimizing the created segments by ranking each of the created segments based on the statistical differences;
means for mapping the created segments into a geographic distribution, resulting in a virtual panel;
means for saving the virtual panel.

16. The virtual panel modeling apparatus of claim 15, wherein the minimum number of transactions per account record is at least one merchant category in the current and previous month.

17. The virtual panel modeling apparatus of claim 16, wherein the maximum number of transactions per account record is twenty merchant categories in the current and previous month.

18. The virtual panel modeling apparatus of claim 17, wherein the computing the statistical difference based on the derived industry spend distribution with the actual census spend distribution is derived using the Euclidean distance formula.

19. The virtual panel modeling apparatus of claim 18, wherein geographic demographics data is provided by census data.

20. The virtual panel modeling apparatus of claim 18, wherein the set time period is defined by a user computer system.
